(19) United States
(12) Patent Application Publication
(10) Pub. No.: US 2016/0171579 A1
(43) Pub. Date: Jun. 16, 2016

(54) REBRANDABLE STATIONS FOR RETAIL SERVICE OPERATIONS

(71) Applicant: Lori D. Van Deloo, Los Altos, CA (US)

(72) Inventor: Lori D. Van Deloo, Los Altos, CA (US)

(21) Appl. No.: 14/568,136

(22) Filed: Dec. 12, 2014

(51) Int. Cl. G06Q 30/06; G06Q 30/02

(52) U.S. Cl. CPC G06Q 30/0617; G06Q 30/0281

(57) ABSTRACT

Methods and systems for designing, establishing and operating interactive, rebrandable stations, or Pods connected to a Service System to enable service providers to deliver qualified information, advice and agent-assisted services are disclosed herein. Said Pods may be accessed remotely or via Service Centers. A key benefit is the ability for multiple providers to enable secure services through a single Pod. Users once authenticated or logged into a said Pod, can access a plurality of service protocols. Such service protocols may be accessed using self-service tools, or through real-time assisted service. The Service System includes both user- and agent computer systems through which user and agent interactions are enabled. The agent computer system includes a number of service tools available for supporting agent-assistance servicing. The Service System further tracks and compiles session information and data.

### CROSS-REFERENCE TO RELATED APPLICATIONS

This application is a non-provisional application of and claims the benefit of priority of U.S. Provisional Application No. 61/915388, filed on Dec. 12, 2013.

### STATEMENT REGARDING FEDERALLY SPONSORED RESEARCH OR DEVELOPMENT

Not Applicable

### REFERENCE TO SEQUENC LISTING, A TABLE, OR A COMPUTER PROGRAM LISTING COMPACT DISC APPENDIX

Not Applicable

### FIELD OF THE INVENTION

The present invention relates to systems, methods, mechanisms, and architectures for providing retail services.

### BACKGROUND OF THE INVENTION

Many consumer and retail services are best provided by real-time interaction between a customer and a human service provider, either in a face-to-face or remote context. Such interactions promote brand loyalty, encourage and support customer confidence and comfort, and provide marketing, upselling and cross-selling opportunities. Some transactions, such as tax services, insurance services, retail banking, wealth management planning or other retail services, involve transfer and exchange of expert knowledge or defined physical instruments (such as sources of identification, cash and checks) that require customers to either visit a representative at a physical retail location or interact with an automated teller machine, kiosk, or similar device. In other instances, availability of such physical retail locations offers convenience to the customer to access services whenever, wherever they choose.

However, a dedicated retail service site with live, on-site personnel (such as a retail outlet or bank branch) can be prohibitively expensive to establish and run. In some areas and markets, the volume of customer traffic does not justify the costs of running such a site. In other areas and markets, the available retail locations may be limited, or due to the prohibitive expense may only be available to service providers' with enough capital to acquire the desired retail service site.

In an increasingly digital world, users may be accustomed to performing many tasks over the phone, online or via a mobile device. However, a significant quantity of customers is still more comfortable engaging with live service providers at a dedicated site that provides face-to-face interaction, or provides the ability to talk to someone or chat with them over a video communication device in real time. Alternatively, another segment of customers do not always have a full understanding of products and how to properly fill out an application or request so the ability to access a live agent can allow customers to immediately answer questions and gain assistance to complete transactions. The inability of conventional service providers to continue to provide such on-site services at physical locations can lead to customer dissatisfaction and/or defection. Furthermore, the inability to have access to service providers may limit the ability of some segments of the population to have the proper literacy to select, apply, register, activate and/or use a given service. As such, these segments of users may be left out of receiving formal services. Accordingly, an opportunity exists for retail service industries to improve their efficiency and performance in providing such on-site services at physical locations, so as to restore and/or maintain feasibility of operation and thereby improve the customer experience and increase customer satisfaction.

Embodiments of the present invention address these and other problems, individually and collectively.

### BRIEF SUMMARY OF THE INVENTION

For purposes of the description, the following terms are defined:
Service provider: any provider of services, including for example and without limitation, a retail services provider, tax preparation service provider, bank, financial services provider, loan officer, insurance provider, healthcare services, travel agent, and/or the like. For the purposes of the following discussion, the terms “Service Provider”, “Provider”, “branded-Provider” are interchangeable.
Agent: A representative acting on behalf of the “service provider.”
Customer or user: any consumer, client, small business owner, or other entity that is being or can be served by a service provider according to the techniques described herein.
Service System: the underlying computer network that operates the Pods according to the techniques described herein.
Pod: an interactive station using any combination of input/output devices to allow a customer to engage with, communication with, and transact with a service provider according to the techniques described herein. Input/output devices may also include consumer portable devices, such as personal computer system devices, personal digital assistants (PDAs) or any other suitable stationary or portable input/output devices. As described herein, such Pods can be dynamically rebrandable to enable and support access to different providers and their respective services. For purposes of the following discussion, the terms “Pod”, “Pod station”, “interactive station”, and “station” are interchangeable.
Service Center: a physical location where users can gain access to one or more Pod stations.

According to various embodiments of the present invention, a physical location is established at which a plurality of rebrandable, interactive stations (“Pods”) contain interactive technology that implements and supports face-to-face interaction with remotely located service providers. Although the invention is capable of supporting face-to-face interaction with human beings over a remote audio and/or video link, one skilled in the art will recognize that the techniques described herein can also be applied to provide rebrandable stations that support fully automated transactions, which may not necessarily involve real-time interaction with a human being.

A given site can include any number of Pod stations that can be instantly rebranded on an “on-demand,” real-time basis. A site can contain one such “Pod” or any other number of Pods. Stand-alone single-Pod sites may be particularly useful where space is at a premium or where mobility is desired. For example a single-Pod station may be useful within an existing retail outlet, mall, airport, supermarket, hotel lobby, campus or the like. A Pod may be mobile and can be set up on a temporary basis, if desired.

For example, when a customer walks in and indicates a need for retail banking services, a station can be instantly rebranded as a banking services station, complete with logos, color schemes, and interactive elements appropriate to the customer's particular bank. Similar rebranding can take place in response to a need for travel services, tax preparation services, healthcare services, insurance services, and/or the like. A site containing two or more stations can be configured so that the stations are branded differently at any given time, depending on the current needs of customers who happen to be at the location at any given time.

In at least one embodiment, each individual station contains reconfigurable input and output technology components that allow the customer to interact with and/or request assistance from remotely-located service providers and their respective agents (and/or request their underlying services) on a real-time basis. Such technology components can further be configured to change their appearance and operation so as to reinforce the service provider's brand and to provide particular user interface elements tailored to the needs of that service provider and its customers.

The present invention thus exploits the fact that multiple service providers, either in the same or different industries, may wish to provide access to real-time, on-site services at the same physical location, while retaining the ability to promote their own individual brands. The present invention provides a mechanism by which such service providers can use Pods to establish, maintain, and support services in a manner that promotes their brands and provides many of the advantages of conventional physical branches or retail locations, with the intent to provide more points of service access for customers, and significantly lower costs for participants. In addition, the present invention provides mechanisms by which service providers can easily enter or exit a particular market at a particular location, at a particular Pod, and/or flexibly scale their operations over time in response to increased or decreased customer demand.

### BRIEF DESCRIPTION OF THE DRAWINGS

FIG. 1 is a schematic diagram of a Service System that can include various embodiments of the present invention.

FIG. 2 is a schematic that shows examples of various methods for accessing Pod stations that are connected to the Service System, and a schematic that shows the Pod input/output screens and associated flow of service protocols within various embodiments of the present invention.

FIG. 3 is a high-level service flow for gaining access to Pods according to various embodiments of the present invention.

FIG. 4 is a high-level block diagram of an agent computer system and tools that may be used to implement various embodiments of the present invention.

FIG. 5 illustrates a method for generating agent service protocols according to an embodiment of the present invention.

FIG. 6 provides a block diagram of the system and methods for collecting, compiling, and managing data collected in connection with usage and interaction with the system, in accordance with various embodiments of the present invention.

### DETAILED DESCRIPTION OF THE INVENTION

Embodiments of the invention disclosed herein include systems and methods for operating a reconfigurable Pod connected to a Service System. The Service System enables the Pod Computer System to interact with service providers' offerings that are enabled through at least one said Pod, or can be offered through a plurality of Pods. The Service System also operates the Agent Computer System that allows for customers to interact with agents while navigating available services. The user and agent interfaces can be accessed via Pods located in a Service Center or via remote telecommunication methods. The underlying interaction model is managed by the Service System that controls the interaction between the customer computer system and agent computer system. This Service System stores in remote database memory the instructions and process flows for executing a plurality of different service protocols available for different customers for different service providers.

Embodiments will be illustrated with reference to specific implementations. However, one skilled in the art will recognize that such descriptions are merely exemplary, and that the invention can be implemented in many contexts, service verticals and environments, so as to enable different types of customer services. Indeed, a particular advantage of the present invention is the ability to instantly reconfigure a station to function in any of a number of different ways and to enable different types of services to the benefit of multiple customers and multiple service providers.

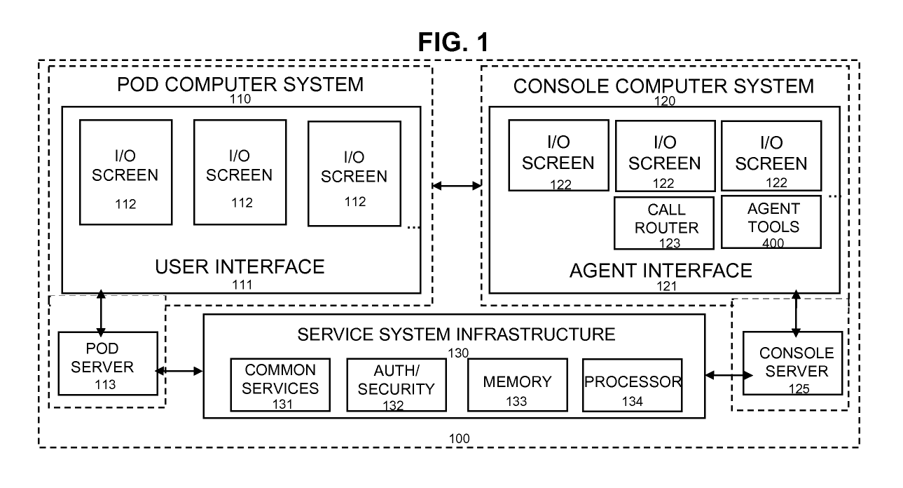

FIG. 1 is a high level block diagram that illustrates the primary systems and methods for operating a reconfigurable Pod and associated underlying Service System 100. The Service System includes the following subsystems: a Pod computer system 110 with associated user interface 111 and Pod server 113, a console computer system 120 with associated agent interface 121 and console server 125. The Service System 100 is also supported through Service System infrastructure 130 that includes: common services 131, authentication and system security 132, memory 133 and a system processor 134. The Service System is accessed through at least one said Pod station that is operated by the Pod computer system 110. Pod stations can be located in a Service Center or accessed via remote communication methods.

In at least one embodiment, the systems and infrastructure described herein, support bank-grade, secure-socket layer (SSL) encryption to allow for the secure transmission and handling of messages and information. Database management systems, likewise, can employ the necessary security levels to safeguard customer information and usage data.

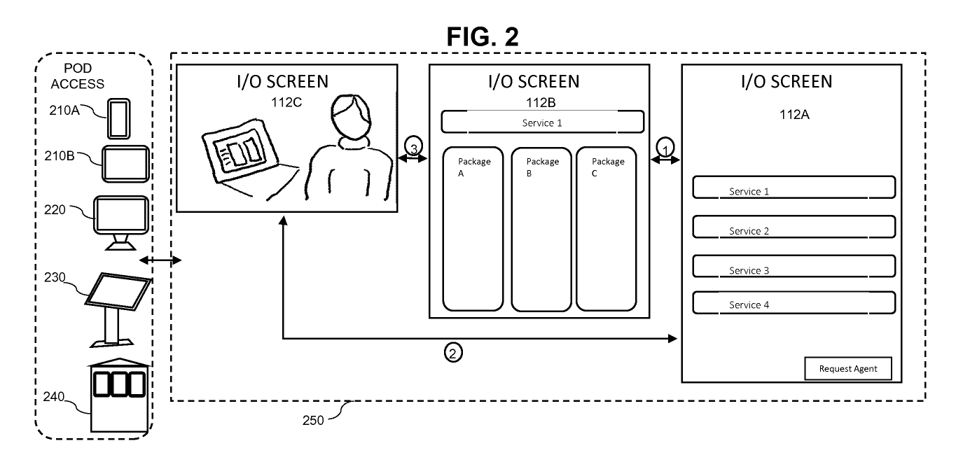

FIG. 2 is a schematic that shows examples of various Pod access methods for Pod stations that are connected to a Service System, and a schematic that shows the Pod input/output screens and associated flow of service protocols within various embodiments of the present invention. Pod stations may be accessed using any number of suitable devices including, but not limited to: consumer portable devices used for remote access such as mobile phones 210A and mobile tablets 210B, combination PC/tablets or desktop PCs 220, standing kiosks with one or more suitable input/output devices 230 or physical structures connected to one or more input/output devices 240 that can be operated locally or remotely to connect to the Pod computer system 110.

The flow of service protocols illustrated in FIG. 2 demonstrates the Pod interaction model 250 as executed within various embodiments of the present invention. Each screen has the ability to support voice, video and/or data-driven requests and protocols. Step 1 of the interaction model 250 shows that requests can be initiated on one input/output screen 112A and response received on a second input/output screen 112B. Similarly, in Step 2 of the model 250, a request can be initiated in one input/output screen 112A and sent to yet another input/output screen 112C that for example might be a user requesting to talk to a live agent. In Step 3 of the model 250 the agent responds to the user's request for information by providing a response back in the second input/output screen 112B. The interaction model is flexible and can be customized to support execution of a number of different service protocols with varying flow steps that can include both self-service elements and agent-assisted elements.

In one embodiment, the system operates in response to a customer's request for a particular type of service, using the customer self-service request features of the system. A few examples of such requests at providers in different verticals include: access product information when opening a new account such as with a wealth management provider, complete an automated registration for a given service such as signing up for medical insurance with a healthcare service provider. The Service System can be accessed via Pods for any of a number of different service requests made available by service providers.

In at least one embodiment, internal technology/communication tools and infrastructure in the Pod can be used separately or in an integrated fashion. One example of an integrated approach is as follows: customer initiates a user session at a Pod station; user requests to talk to an agent; live agent answers request and is connected via a real-time video call with agent image visible to user; agent has live conversation with customer; agent shares screen with user. At the same time, the user can be executing a transaction (e.g., filling out an application) while still meeting and collaborating with the agent via voice, video and data-enabled communications.

In another embodiment, the Service System may be used to complete a transaction that was previously initiated either in a Pod or in another channel operated by the service provider. For example, a user may have initiated an online registration process through a service providers' public website, and then paused and saved her progress to be resumed at a later time. The session was then subsequently resumed at a Pod to allow the user to gain access to a live agent for help in choosing the most appropriate products and receive assistance to fill out the registration. Such pause and resume functionality is managed by the Service System, and can be implemented at the session level or service level. The function can also be initiated by the customer user controls provided as part of Pod computer system 110 user interface 111, or can be initiated by the agent, through the agent interface 121 of the console computer system 120. Service can be resumed in the same Pod or in a Pod not previously used for the initial session with the said service provider.

The user may have one or more accounts associated with different providers that each employ the use of Pods connected to the underlying Service System 100, and/or may allow use of multiple Pods that are located in a Service Center or accessed via remote communication methods or a combination of both, to access their respective services. In at least one embodiment, the system of the present invention can provide improved client service in Financial Services, Retail, and/or the like, and is configurable and customizable so as to provide any suitable combination of such services for any service provider who enable their respective services through the same Pods. Automated services can be provided in an easy-to-use manner that can allow up to 24/7 access to Pod stations that in turn can provide access to qualified information, live support and real-time interaction. Real-time interaction service protocols can be used to support delivery of services includes the ability to access and talk to a live agent on-demand, collaboratively browse and share information, and collaboratively author documents and other works. One of the benefits of the Pod stations is the ability for the user to conduct at least two or more of these activities simultaneously based on available services and allowable service protocols for a given user without having to navigate back and forth through service steps.

In at least one embodiment, the present invention is implemented as a multi-tenant concept such that multiple providers can enable their services through at least one of the same said Pods. This said Pod may be configured to be directly accessed by users at a defined Service Center location. The invention can be implemented, for example, as a new form of shared retail branch outlet that uses a single physical storefront to serve multiple service providers in a single vertical market such as financial services or can be used to serve providers operating in a plurality of different vertical markets such as financial services, healthcare, and other consumer or business services.

According to at least one embodiment of the present innovation, a Service Center site may include a collection of Pods presented with large display screens capable of displaying branding information for a number of different service providers. For example, one of the Pods could be branded “ABC Bank” in anticipation of service for a customer of that bank. In at least one embodiment, additional elements, inside and/or outside the Pod, can be presented to reinforce the brand both visually and operationally. The additional elements can be generated or retrieved, for example, on customer log-in or directory request of an underlying service provider's service.

Using the above-described techniques to access the Service System 100 via Pods located in a Service Center, the present invention enables collaborative consumption of real estate, in-branch technology and logistics to achieve efficiencies, lower cost to serve, and improved overall customer satisfaction, whether used by providers in a single vertical market such as financial services only or healthcare services only, or a combination of service providers in different vertical markets as discussed herein. This shared operational infrastructure for accessing separate, different providers could be of particular use in locations within urban areas where space is limited and associated real estate costs are at a premium, or rural areas where populations are more spread out, thus cost-effective reach and access to customers is more challenging for services providers. Providing such a cost-effective alternative will bring greater choice and selection of services to consumers and businesses of all sizes.

In at least one embodiment, the invention can be implemented using enhanced functionality and shared value-added services, such as for example package delivery “locker” services co-located at a Service Center. The user may be given the opportunity to request such services from the Service System, if appropriate. Such requests may be authenticated and confirmed via the services protocol interaction. Services can be provided for any user regardless of Pod access devices (e.g., 210A, 210B, 220, 230, 240). One skilled in the art will recognize that other value-added services, as accessed through the main services protocol can be made available by or in connection with the present invention.

Greeter Station

In at least one embodiment, at least one Pod input/output screen 112 is used as a greeter station, which may include a directory, authentication, and/or log-in functionality. The greeter station may be, for example, operated using a Pod access device that can be used for login of all Pods at a said Service Center 240. Alternatively, there can be multiple greeter station-enabled access devices or even one greeter station operated independently per Pod. For Pod stations accessed via remote methods authentication and login can be executed through remote authentication methods (e.g., name/password or remote tokens). Alternatively, Pod station access may be governed by authentication credentials and login procedures associated with existing secure sessions—e.g., in remote access via secure socket layer (SSL) behind a fire wall such as once logged into an online banking session for a Financial Institution.

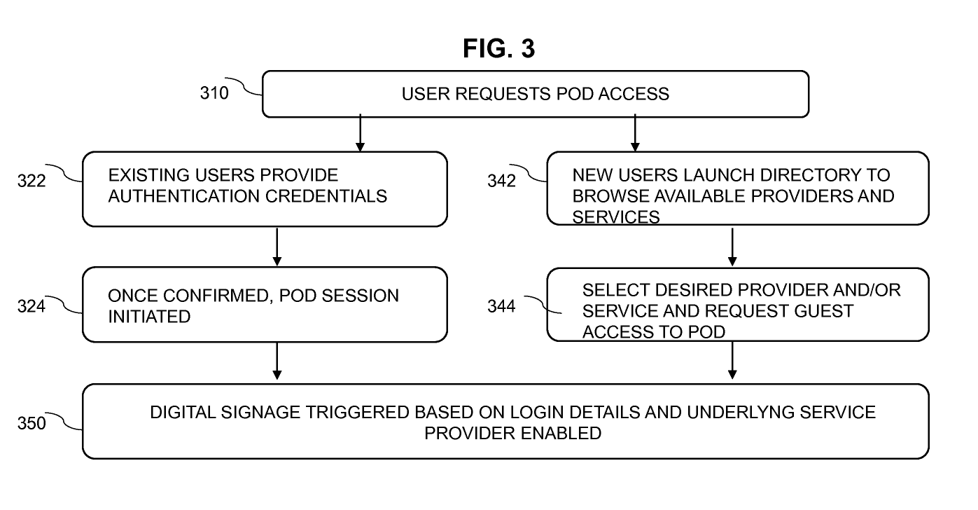

FIG. 3 is a process flow for depicting the interaction with the greeter station for the invention according to one embodiment. A user requests Pod access 310, either by physically approaching or entering a Pod station at a Service Center, or by requesting Pod access via remote communications methods. Process steps will vary based on if the user is an existing user of a given service provider or if the user is new and does not previously have an account at any said service provider. If an existing user, user will be asked to provide authentication credentials 322. Once authentication is confirmed, the Pod session is initiated 324.

The user (or customer) interacts with a login or directory input/output screen, accessible either directly or via the customer's portable or mobile device. Any suitable computer-based system with standard and/or touchscreen device can be used. The Pod server processes and routes the login/authentication data requests and retrieves, from a service provider computer, validation results of the authentication request. Based on such results, the Pod server transmits information to a designated user input/output screen 112 as defined by a said service protocol to allow interaction with the user, while employing suitable branding according to the service provider's defined protocols and preferences.

Customer identification and authentication can take place using any suitable technique or combination of techniques using one, two- or multi-factor authentication methods. Authentication elements can be composed of a combination of static and/or dynamic authentication data elements to allow access to any Pod Station connected to the Service System. Possible data elements include without limitation: password input, biometrics (e.g. fingerprint scans, retina scans, vein scans), facial recognition, voice recognition, identification card, and/or the like. In at least one embodiment, Pod customization such as digital signage and enabled services, takes place automatically in response to customer identification and/or authentication, so that the Pod signage and surrounding environment signage as appropriate, change and adapt to the appropriate service provider appearance based on the identity of the customer or customer log-in request 326. For example, if a customer of ABC Bank is identified (for example, upon entering their authentication credentials at a Greeter Station on a Pod input/output screen 111 located at a Service Center), a Pod can be automatically and instantly customized to display the ABC Bank branding elements, and the customer can be directed to that specifically identified Pod upon entry or presentation at the greeting kiosk.

In at least one embodiment, APIs can be used to allow providers to integrate authentication at a Pod with existing systems. For example, in Financial Services, the system can allow for integrated single sign-on using online banking, mobile banking, and ATM/branch banking technology and credentials.

The log-in process may include use of any suitable alternative form factors such as mobile devices, and the use of credentials or authentication data elements that are generated and managed through the Service System. Examples of such identifiers include use of QR codes, tokens, verification values, PINs, name/password, site keys, picture ID, social network login, biometrics and other forms of account and account holder authentication methods. The Service System can also operate on behalf of a service provider or for stand-in processing of verifications based on authentication methods and credentials already generated, stored and managed through a said service provider. Furthermore, the Service System can operate a log-in process that allows the service provider to request a combination of multiple authentication methods and credentials that may be a mix of those generated, stored and managed by the Service System and by the service provider. Authentication credentials can be stored at any suitable location, whether local, remote, or cloud-based, or any combination thereof.

For new users interested in gaining Pod access, since no prior profile exists, a directory is launched to enable browsing of available providers and services 342. The directory will be of assistance to new customers in particular who want to learn about available products, services and providers, but do not yet have an associated account with a given service provider. The new user will then be asked to select their desired service provider and/or services and request access to login to the Pod as a guest 344.

After the customer logs in (whether authenticated or not authenticated in the case of a new user), the welcome screen can include customized elements according to the brand 350 of the service provider associated with the customer account, profile and/or preferences. The color scheme and visual elements on the welcome screen are consistent with the brand of the service provider. The Service System allows for each service provider to select branding preferences.

For Pods located in a Service Center, once a customer completes log-in, the customer will be directed to one of the available Pods, which has been customized to reflect the branding of the service provider 350. This customization may occur on one or more input/output devices and digital signage screens as available. Branding can be provided and displayed on the outside of the Pod and/or inside the Pod.

Pod Station Service Interaction and Service Protocol Delivery

As described herein, according to various embodiments of the present invention, elements of the Pod can facilitate service interactions to enable access to the underlying providers' services. When a Pod located at a Service Center, digital signage on the interior or exterior of the Pod can be programmed to display specific branding related to services requested by user, or as a result of validating customer log in or authentication. When a Pod in a Service Center is vacant, available digital signage can be used for specific service provider information and/or remain unbranded, and/or any other suitable combination herein. The digital signage input/output screens can also be operated by the service system separately from that designed to support service providers and be employed for general purpose information and use.

In at least one embodiment, the walls can connect to alternate systems such as notification systems for sending and/or receiving information. For example, information on the digital wall inside the Pod could be sent to customer's email if requested, by touching a “send to email” button on wall or touchscreen; alternatively, such a process can be triggered remotely by a live agent (such as a mortgage specialist or any other agent representing a given service provider). User notification systems can be any suitable system operated by brand/service provider or other third party and delivered, for example, via user email or SMS message service accessible via a consumer portable or desktop device, or provided as a printed copy using a printer or other hardware peripheral device connected to at least one said Pod connected to the Service System 100.

Given that a key benefit of the service is the ability to interact with a live agent, in real time, the combinations of process flow steps are numerous and can be uniquely designed in advanced or determined based on the flow of the conversation, in real-time in the context of a given user session.

The agent interface sub system 121 that operates as part of the console computer system 120 provides an interface for the agent to communicate with the user. The interface includes one or more input/output screens 122 that provide access to audio, video and/or data-enabled communications. Agents can be assigned an agent ID or other identifier to associate a specific profile that is tied to credentials, preferences and/or permissions for a given agent; this is managed by the call router 123 that operates as part of the console computer system 120. The agent interface also provides access to a set of agent tools 400.

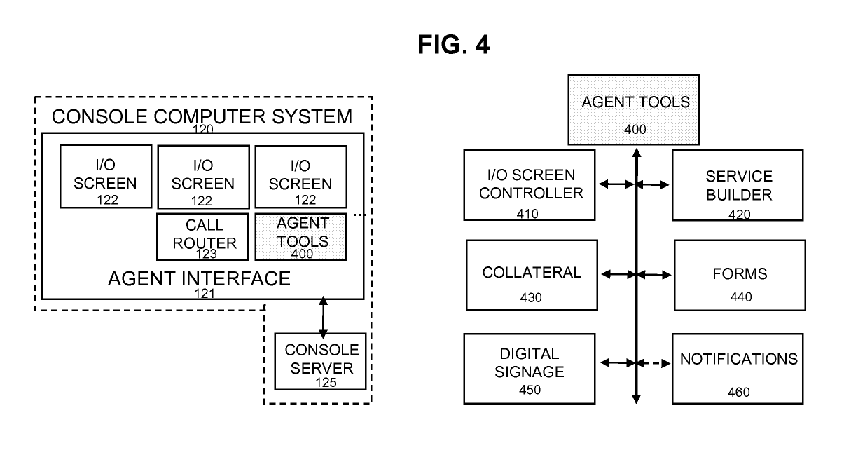

FIG. 4 is a block diagram depicted the detailed view of agent tools 400 available in the agent computer system that may be used to implement various embodiments of the present invention. Agent tools 400 can be configured by both service provider administrators and agents directly depending on set permissions. Available agent tools 400, and associated services and information may be pre-defined by a central service provider administrator using the console system 120 and/or agents may be given the ability to directly create their own services using the service builder 420. Other information available to agents via the console system 120 include a directory of relevant collateral 430 and forms 440, necessary to complete transactions. Agents also have access to digital signage controls to allow for use of branding and signage to be shared when any given Pod input/output screen 112 is idle. Further, notification options 460 are available if an agent needs to, for example, email information to the customer after the session or confirm any details about the transactions conducted during the Pod session, as appropriate. Additionally, an input/output screen controller 410 manages the overall connections to different access devices. Agents override capability can redirect content to different input/output screens as needed and available, to satisfy customer requirements.

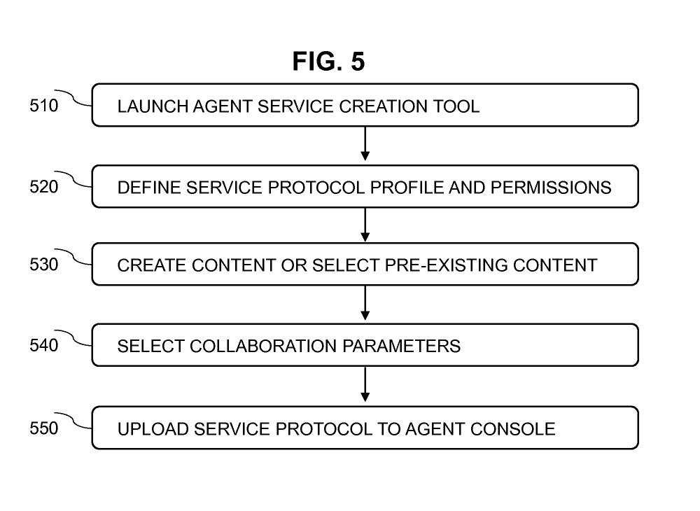

FIG. 5 illustrates a method and provides steps for generating agent servicing protocols according to an embodiment of the present invention. Agent servicing protocols can be creating using the agent service builder 420. An example of how to use the service builder is as follows: the first step 510 is to launch the agent service creation tool which can be accessed in the agent tools 400 section of the agent interface 121. The second step 520 is to set up the service protocol profile and associated permissions. This provides the framework for what the purpose and focus of the protocol is and how and who can use it and in what situations it can be used. The third step 530 is to populate and/or link the content associated with the protocol. Content can be linked from a variety of different resources as made available by the service provider administrator. The fourth step 540 is to set the associated collaboration parameters allowed for sharing the content with customers. Once completed, the last step 550 is to upload the service protocol which will be made available via the agent interface 121.

The communication devices may then provide notification to users as to status of transactions and other information, via any suitable communication mechanism such as, for example, email, a portable/mobile device, and/or printed hard copy provided by a printer located within a service center or pod. Any of these notification systems 460 can interface with a system associated with the service provider and/or with a third-party notification provider system.

As described above, various embodiments of the present invention can provide variations including different types of cross-communication tools, customizable flows, and/or interactions. In other embodiments, the Pod can provide other communication mechanisms, such as for example an audio-only call center, chat functionality, and/or the like.

In various embodiments, the Service System 100 can be linked to any suitable notification system(s) provided by any available service provider or other third party provider. Examples of particular types of such notifications that can be delivered include messages via web page, tablet, and/or smartphone.

Service templates, APIs and integration services can be provided to connect to providers' back ends or existing software/systems/platforms.

In at least one embodiment, Pod Stations can be integrated with full cash dispensing and cash/check deposit acceptance capabilities, document signature capabilities, document scanning and image capture, integration with notification systems (e.g., email, SMS/text and printers), and/or the like.

Service System Analytics Management Platform

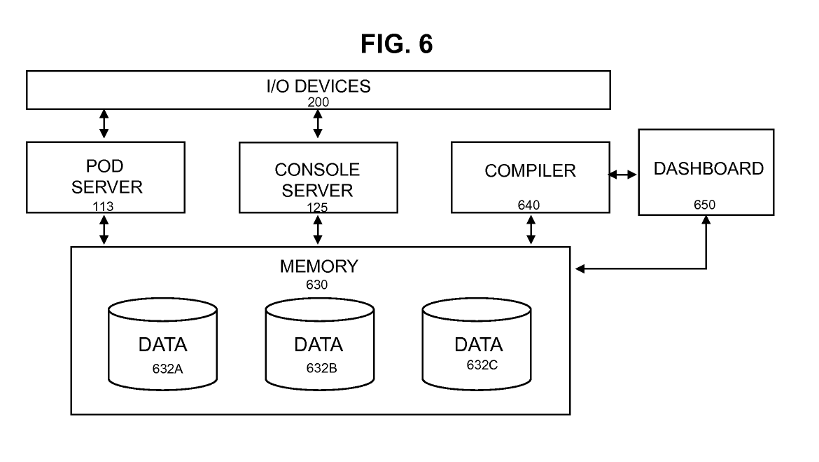

FIG. 6 provides a block diagram of the system and methods for collecting, compiling, and managing data collected in connection with usage and interaction with the system, in accordance with various embodiments of the present invention. The system analytics platform is part of the Service System infrastructure 130 operated as part of the common services 131 that supports the entire system.

In at least one embodiment, the system of the present invention enables capture and manipulation of data so as to provide utilization data analytics for customer interactions for respective service providers' customers. The underlying common services platform 131 manages analytics rules, processing and structure. Various embodiments of the present invention provide mechanisms that allow data 632 to be captured and organized into logical data sub-sets (e.g., 632A, 632B, 632C) in memory databases 630. The analytics compiler 640 allows data to be aggregated and/or analyzed to ascertain trends, create predictive probabilities and the like. Data 632 can be housed and managed in a distributed manner across services, providers, branches and the full network, with appropriate permissions. The data and resulting analyses can be made available to service providers via an online portal or dashboard 650.

Various examples of data and data analytics that can be collected and generated using the compiler 640, include for example and without limitation: service directory data, registered user/account data, authentication data, Pod usage data, service protocol usage data, service provider data, digital signage data, new user data, user preferences/permissions data, user history data, message session/history data, value added services usage data and notification data.

The analytics protocols provide instructions for data elements to be collected, compiled and stored. Data elements are collected from usage of the Service System, with specific emphasis on data collected from the Pod usage and administration delivered by the Pod server 113 and agent interactions delivered via the console server 125. A notable trait of the analytics platform is the ability to collect data elements based on real-time interactions throughout the end-to-end service access and delivery process, as the system is fully automated.

In at least one embodiment, value-added services and service enhancement requests and transactions can be integrated into usage and experience statistics. For example, logistics and package tracking can be implemented. In addition, customer support and satisfaction surveys and responses can be integrated with data usage statistics. Such data would be transmitted via the Pod server 622 and console Server 624, as applicable, similar as it would other data related to Pod session and service protocol interactions.

Alternative Embodiments

The following is an exemplary list of service provider categories for which the rebrandable stations of the present invention can be used. One skilled in the art recognizes that said Service System could support service providers across a number of different service industry related segments as defined by the North American Industry Classification System (NAICS). In various embodiments, the invention can be used to provide any suitable combination of Pod stations for such service providers, at the same location or provided separately. The invention is not intended to be limited to the particular examples shown and could also be intended for use a plurality of service verticals including without limitation: Financial Services, Accounting Services, Cable, Internet, Wifi, and Communications Services, Concierge and Hospitality Services, Consulting Services, Document Signing and Notary Services, Education Services, Escrow Services, Government Services, Tax Services, Healthcare, Health Professional and Pharmacy Services, Insurance Services, Legal Services, Mortgage Services, Real Estate Services, Title Services, Utility Services, Search and Information Services, Ticketing Services and other retail services. Financial Services referenced herein include without limitation: retail banking services, brokerage services, cash flow management, budgeting and spend management services, deposits, money movement, payments including bill payment services, treasury management services, wealth management services, retirement planning services, private client services, and other financial advisory services.

Alternative variations includes different services accessed and enabled through the Service System. The service tools purposefully allow for the creation of any number of different services by a qualified agent, administrator or other third party acting on behalf of the service provider.

For the software components or functionality described herein, a plurality of development and implementation methods exist. Software code can be developed using any suitable computer language, such as for example, but not limited to: Javascript, C#, C++, Visual Basic, Ruby, Ruby on Rails, SQL, and SAS. Storage of the software code may be conducted as a series of instructions on a computer-readable medium and accessed directly or provided as a service on-demand for each request.

1. A method comprising:
operating a reconfigurable Service System comprising at least one server, a database with remote database memory linked to said at least one server, said at least one server accessible over a computer network using a plurality of Pod stations;
each Pod comprising at least one processor, local memory, and at least one input/output device,
at least some of said plurality of Pods configured to be directly accessed by users at a defined Service Center location;
wherein at least some of said plurality of Pods are configured to be independently accessed by users via remote communication methods;
storing secure, Pod access criteria and access permissions for a plurality of users and plurality of service providers in said database;
storing a plurality of different service protocols in at least said remote database memory, each said service protocol comprising service specific interaction instructions, user interfaces, and service agent interfaces that control how Pod input/output devices interact with users;
wherein said service agent interfaces provide an interactive-service protocol that enables said users and said service agents to communicate over at least one communications network in real-time as controlled by either said user or said service agents;
wherein said user interfaces and said service agent interfaces further comprise instructions to allow said user interfaces and said service agent interfaces to be automatically configured in real-time by either said at least one server or said Pod device to coincide with specific interactions requested and in use by any of said service agent and said user; and
using said at least one server to generate notifications of requests, validations and executed actions across any of said plurality of users and servers.

2. The method of claim 1, wherein said service agent interfaces running on said at least one server further provide at least one service agent console portal that allows service administrators with validated access permissions to use administrator templates to create and modify said service protocols and access permissions for specified services enabled in Pods.

3. The method of claim 2, wherein said at least one service agent can create, access and modify in real-time, service protocols based on interactions requested during a Pod station session.

4. The method of claim 2, wherein said service administrators can use administrator templates to create and modify said service protocols to be provided to a defined set of one or more service agent consoles.

5. The method of claim 1, wherein using said at least one server to validate user access permissions, and upon proper validation customize and present user access to at least one service using either said Pod station or another device connected to said Pod station.

6. The method of claim 1, wherein said Pod station further comprises an additional check-in directory system configured to allow at least one user to select a service protocol from said plurality of service providers and associated service protocols.

7. The method of claim 1, wherein said Pod station further comprises at least one user authentication system, further using said at least one user authentication system to validate access permissions for at least one user.

8. The method of claim 7, comprising the validation steps that may take place in whole by a single party or on-behalf-of, or in combination therein.

9. A computer readable medium storing instructions and commands for causing a processor to implement the method of claim 8.

10. The method of claim 1, wherein at least some of said Pods said at least one input/output device comprise at least one Pod console touch screen with input/output device functionality, and wherein at least some of said plurality of different service protocols comprise service templates, API and integrated services configured to interface said at least one Pod console touch screen input/output with said at least one server.

11. A method of claim 1, wherein the reconfigurable Service System operates the computer system that controls the service delivery for different service providers and validating access criteria and access permissions.

12. A method of claim 11, wherein the Service System delivers different sets of service protocols for each service provider including product and service information, planning information, analysis information, portfolio information, comparative information, account openings, and account service registrations.

13. A method of claim 11, wherein the Service System operates the computer system that stores the service providers' and users' preferences for delivery of different service protocols for access using different input/output devices connected to said Pod stations.

14. A method of claim 1, wherein usage of the Service System can be paused by a user on one said Pod station operating in either a Service Center or remote telecommunication method, and subsequently accessed on a second said Pod station operated in either a Service Center or via remote telecommunication method.

15. A method of claim 14, wherein a connection to a user session accessing the Service System on one said Pod station operating in either a Service Center or remote telecommunication method can be paused by a service agent and subsequently resumed on either the same said Pod station or a different said Pod station.

16. A method of claim 1, wherein the reconfigurable Service System operates the computer systems that controls the service delivery of service protocols enabled for any said service providers in any of said service industries including, without limitation: accounting, communications, hotel/hospitality, concierge, consulting, notary, education, escrow, financial advisory, financial ATM, financial brokerage, cash flow management, deposit, lending, credit, money transfer, money exchange, bill payments, private client, spending management, treasury, other financial, government, healthcare, insurance, legal, mortgage, pharmacy, real estate, retail, retirement planning, search or information, tax preparation, ticketing, title company, utility, or wealth management services.

17. A system comprising:
system protocols for capturing, compiling and storing Pod session statistics
at least one server set up to receive Service System generated data and store in either local or remote database memory

18. The method of claim 17, wherein said at least one or more Pods or said at least one server are further configured to automatically or on-demand compile and store in either said local memory or said remote database memory, specific set of data elements regarding one or more user authentication, service provider access, services usage and Pod station user session statistics.

19. The method of claim 17, wherein at least one said server is further configured to aggregate said data elements across at least one Pod usage session.

20. The method of claim 19, wherein either at least one Pod or said at least one server is further configured to provide a management dashboard to allow access to said data and reports pertaining to said data.
